(19) United States
(12) Patent Application Publication
(10) Pub. No.: US 2025/0362377 A1
(43) Pub. Date: Nov. 27, 2025

(54) SIMULTANEOUSLY NULLED MONOPULSE AESA SUM AND DIFFERENCE BEAMS WITH FAST ARRAY TEST ENVIRONMENT CALIBRATION

(71) Applicant: Rockwell Collins, Inc., Cedar Rapids, IA (US)

(72) Inventors: Connor McBryde, Cedar Rapids, IA (US); James West, Cedar Rapids, IA (US)

(21) Appl. No.: 19/216,321

(22) Filed: May 22, 2025

Related U.S. Application Data
(60) Provisional application No. 63/651,669, filed on May 24, 2024.

(51) Int. Cl. G01S 7/292; G01S 7/40; G01S 13/02; G01S 13/44

(52) U.S. Cl. CPC G01S 7/2921; G01S 7/40; G01S 13/4463; G01S 13/4472; G01S 2013/0254

(57) ABSTRACT

A monopulse active electronically scanned array (AESA) system includes a phased array of RF channels each having an associated emitter element. A method of operating this system includes identifying a desired nulling location, and computationally optimizing theoretical aperture patterns for the AESA system to align geographically coincident nulls of multiple beams of the AESA system with the desired nulling location, the theoretical aperture patterns including nominal values of gain and a time-based parameter (e.g., phase or time delay) for each of the RF channels. Actual values of the gain and time-based parameter for each RF channel corresponding to these nominal values are calibrated by iteratively bisecting gain and time-based parameter tables, respectively, through successively narrower rangers converging on nominal values. The RF channels are then driven according to these calibrated actual time-based parameter and gain values.

### CROSS-REFERENCE TO RELATED APPLICATION(S)

This application claims the benefit of U.S. Provisional Application No. 63/651,669 filed May 24, 2024 for “SIMULTANEOUSLY NULLED MONOPULSE AESA SUM AND DIFFERENCE BEAMS WITH FAST ARRAY TEST ENVIRONMENT CALIBRATION” by C. McBryde and J. West.

### BACKGROUND

The present disclosure relates generally to active monopulse electronically scanned array (AESA) systems, and more particularly to systems and methods for suppressing ground clutter and other forms of noise or interference in AESA radar and communications systems.

Radar systems, including electronically scanned array (ESA) radar systems, have recently begun to see use in commercial aerospace applications to collect meteorological data. Airborne weather radar can include dedicated weather radar hardware, and/or multipurpose radar systems capable of detecting and identifying relevant weather conditions, but used responsible for other tasks (e.g., collision avoidance, target or surface identification). AESA radar, in particular, offers extremely high resolution at relatively small antenna size by forming multiple beams of radio waves (sum and difference beams) simultaneously, and minimizing composite error signal to locate targets.

Although airborne weather radar systems are also used to detect weather conditions above or around an aircraft, ground clutter presents a special challenge to the collection of useful data from downward antenna beams intended to display doppler returns from, e.g., hazardous weather near a landing location.

Severe weather close to the ground can pose particularly risks to commercial aircraft at low altitudes. More generally, factors such as wind, precipitation, and surface conditions (e.g., water, ice) can determine appropriate flight behavior. Microbursts and unanticipated wind shear can pose particularly high dangers to descending aircraft during landing, when engine power is reduced and landing gear and flaps are extended, and aircraft total energy state is consequently low. Accurate identification of hazardous weather conditions near the ground allows pilots and/or aircraft systems to land safely without false alerts that might otherwise demand landings be discontinued and reattempted, causing increased fuel consumption and longer flight time.

Ground-directed radar is necessary in a variety of application outside of weather detection. Airborne rescue operations, for example, can demand radar identification of targets in need of assistance on the ground or in water. More broadly, any radar application in which ground clutter can tend to overwhelm useful signal presents special challenges for AESA radar systems. There exists a need for radar systems and algorithms well suited to collecting weather and other data near the ground. AESA radar advantageously offers high resolution on an airborne platform, but introduces special challenges as will be discussed below. Existing ground clutter suppression approaches, such as using Space-Time Adaptive Processing (STAP), can be computationally expensive, requiring heavy and expensive hardware and demanding prohibitive amounts of power.

### SUMMARY

In one aspect, this disclosure presents a method of operating a monopulse active electronically scanned array (AESA) system. The AESA system includes a phased array of RF channels each having an associated emitter element. The method includes identifying a desired nulling location, and computationally optimizing theoretical aperture patterns for the AESA system to align geographically coincident nulls of multiple beams of the AESA system with the desired nulling location, the theoretical aperture patterns including nominal gain and phase values for each of the RF channels. Actual gain and phase or time delay of each RF channel corresponding to these nominal values are calibrated by iteratively bisecting gain and phase tables, respectively, through successively narrower rangers converging on nominal values. The RF channels are then driven according to these calibrated actual phase and gain values.

In another aspect, this disclosure presents a monopulse AESA system that includes a phased array of RF channels each having an associated emitter element. A method of operating this system includes identifying a desired nulling location, and computationally optimizing theoretical aperture patterns for the AESA system to align geographically coincident nulls of multiple beams of the AESA system with the desired nulling location, the theoretical aperture patterns including nominal values of gain and a time-based parameter (e.g., phase or time delay) for each of the RF channels. Actual values of the gain and time-based parameter for each RF channel corresponding to these nominal values are calibrated by iteratively bisecting gain and time-based parameter tables, respectively, through successively narrower rangers converging on nominal values. The RF channels are then driven according to these calibrated actual time-based parameter and gain values.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a simplified schematic overhead view of an aircraft-mounted monopulse radar system.

FIG. 3 is a simplified overlay illustrating lobe locations and nulling for ground clutter suppression with the monopulse radar system of FIGS. 1 and 2.

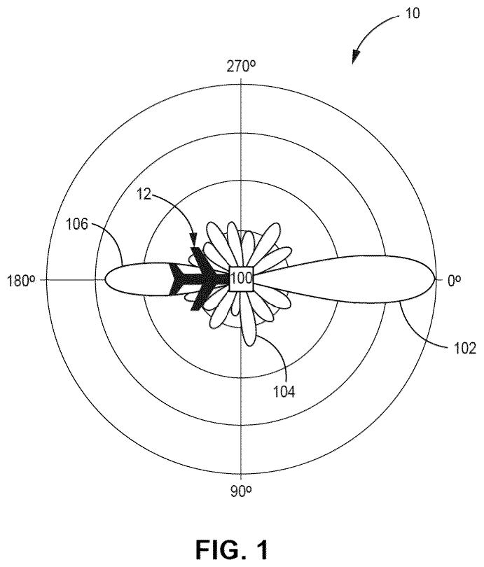

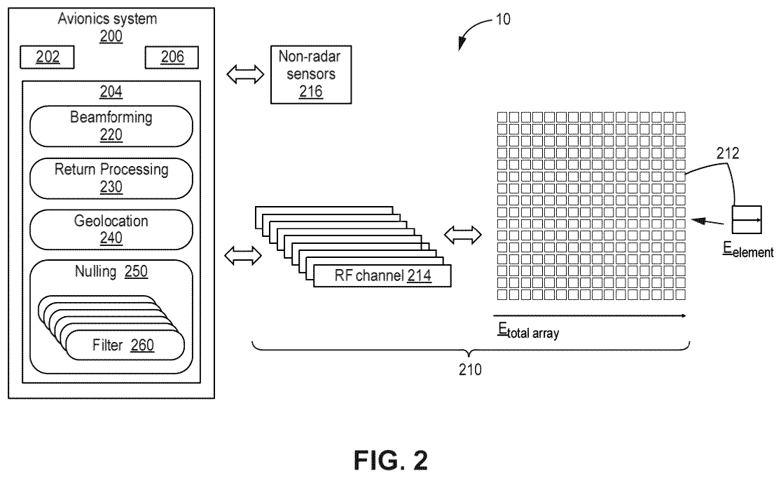

FIG. 2 is a schematic system diagram of the monopulse radar system of FIG. 1.

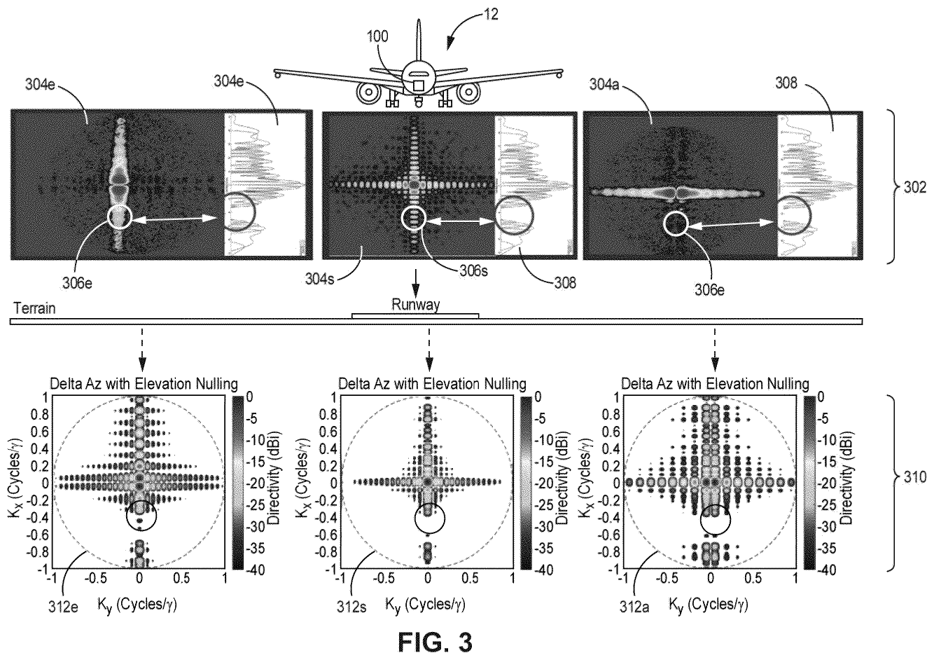

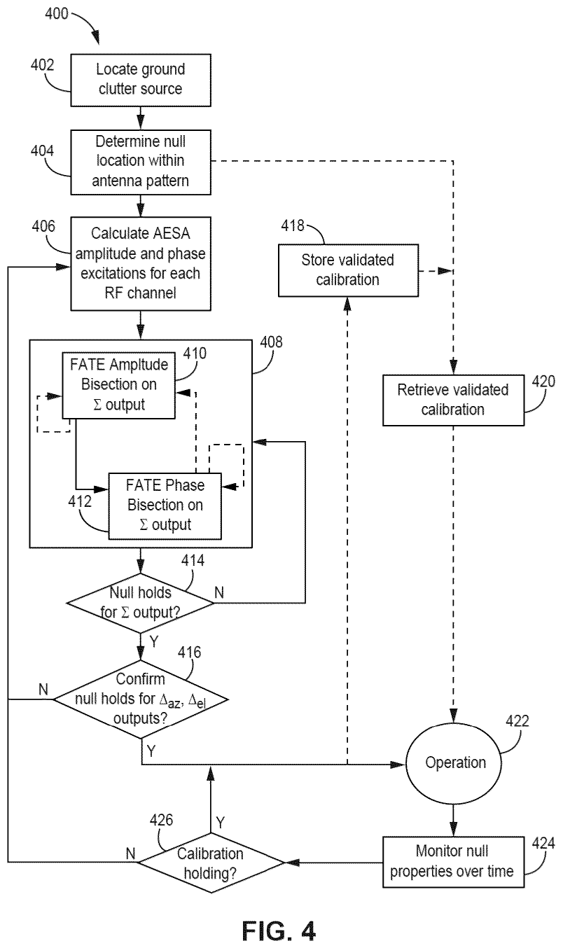

FIG. 4 is a method flowchart describing a process of nulling consistent with FIG. 3, using a FAST Array Test Environment (FATE) calibration approach.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents methods and systems for suppressing clutter in aerial radar systems by simultaneously nulling coinciding portions of multiple beams of a monopulse AESA radar system, with illustrative focus on nulling to prevent ground clutter.

As set forth in greater detail hereinafter, nulling locations are identified and identified relative to the aerial radar system prior to beamforming (e.g., ground clutter sources from surface geography). Beam Forming Integrated Circuits (BFICs) determine amplitudes and phases or time delays of radiating elements of the monopulse AESA radar system are then set to produce far-field nulls at identified locations corresponding to these nulling locations. Nulls of all three beams are maintained coincident with each other at all times, e.g., through particle swarm optimization.

Description herein focuses principally on the nulling of ground clutter-producing components of sum, elevation (difference) and azimuth (difference) beams through a real-time, multi-step process. In addition, however, methods and systems disclosed herein can be used for nulling to suppress other forms of noise or interference, including noise and/or interference originating from other directions.

FIG. 1 is a simplified schematic overhead view of AESA system 10, which can for example be an aerial weather radar system. AESA system 10 is disposed on aircraft 12, and includes monopulse radar 100, a three-beam AESA radar system capable of downward, ground-facing imaging while aircraft 12 is in flight. For simplicity of illustration, FIG. 1 depicts only one of the three beams generated by monopulse radar 100. Monopulse radar 100 includes at least one antenna with multiple (e.g., 1,024) discrete elements, each with dedicated RF channels, coordinated as a phased array to generate beams directed to sweep, scan, or otherwise traverse a space that can include surface geography. As shown in the simplified illustration of FIG. 1, radiation making up a beam of monopulse radar 100 is characterized geometrically by multiple lobes. Although a main lobe 102 may be directed at locations of interest by tuning amplitudes and phases or time delays of radiation emissions from radio frequency channels of monopulse radar 100, sidelobes 104, including back lobe 106, will unavoidably be produced as well. Sidelobes 104 can contribute to undesirable clutter, including ground clutter from ground returns which are the principle example case addressed herein. Although back lobe 106 can have high amplitude relative to individual sidelobes 104, back lobe effects are generally less significant to radar performance than side lobe effects due both to the highly directional nature of “forward looking” AESA radar, and to electromagnetic blockage by the structure of aircraft 12.

The uses and advantages of AESA system 10 and monopulse radar 100 are described principally hereinafter in terms of hazardous weather detection. More generally, however, it should be understood that AESA system 10 can be a radar system used for, and/or include components specialized for imaging of, non-weather phenomenal, including for object detection, collision avoidance, geolocation data collection, search, and rescue. Similarly, although this invention is described mainly in terms of ground clutter suppression, the basic operating principles described herein can be applied to nulling for other applications, e.g., of noise or interference other than ground clutter, or to reduce probability of interception (i.e., LPIR) or detection. More broadly still, although AESA system 10 is described herein principally with reference to radar applications, the methods, devices, and principles of operation set forth herein are also applicable to AESA communication applications with similar benefits, e.g., for reduction of noise, interference, and probability of interception and/or detection.

Referring illustratively to the weather radar application noted above, signal from ground returns can overwhelm signal corresponding to relevant weather conditions if ground returns are not suppressed or eliminated. This is particularly true for weather conditions close to the ground, such as wind shear and microbursts, and for conditions on the ground itself, such as ice or snow, which can present serious hazards to landing aircraft.

FIG. 2 is a schematic system diagram hardware and logic components of AESA system 10. FIG. 2 illustrates avionics system 200 (with processor 202, memory 204, and interface 206) and active electronically scanned array (AESA) 210. AESA 210 can, for example, be a half duplexed Tx and Rx AESA with multiple discrete emitter/receiver elements 212 each having a corresponding dedicated radio frequency (RF) channel 214. Each RF channel 214 can, for example, include a beamforming RF integrated circuit (BFIC) and transmit/receive module (TRM). RF channels 214 are collectively governed and coherently aggregated by hardware, firmware, and software within beamforming module 220 (described below).

AESA system 10 also includes or otherwise receives inputs from non-radar sensors 216. In addition to operating elements of AESA system 10 as described below, avionics system 200 can be responsible for other necessary functions of aircraft 12, including tasks related to navigation, communication, and diagnostics, some of which can involve non-radar sensors 216. Further or alternatively, elements illustrated in FIG. 2 as components of avionics system 200 can be offloaded to separate hardware communicatively coupled to, but separable from, avionics system hardware.

Processor 202 is a logic capable device that can execute software, applications, and/or programs stored on memory 204. Examples of processor 202 can include one or more of a processor, a microprocessor, a controller, a digital signal processor (DSP), an application specific integrated circuit (ASIC), a field-programmable gate array (FPGA), or other equivalent discrete or integrated logic circuitry. Processor 202 can be entirely or partially mounted on one or more circuit boards.

Memory 204 is configured to store information and, in some examples, can be described as a computer-readable storage medium. Memory 204, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 204 is a temporary memory. As used herein, a temporary memory refers to a memory having a primary purpose that is not long-term storage. Memory 204, in some examples, is described as volatile memory. As used herein, a volatile memory refers to a memory that that the memory does not maintain stored contents when power to the memory 204 is turned off. Examples of volatile memories can include random access memories (RAM), dynamic random-access memories (DRAM), static random-access memories (SRAM), and other forms of volatile memories. In some examples, the memory is used to store program instructions for execution by the processor. The memory, in one example, is used by software or applications 1 to temporarily store information during program execution. Memory 204 can, in some embodiments, store calibrations for specific AESA pattern nulling configurations and/or RF channel phases, time delays, and amplitudes, as described in detail below, for cases where such parameters are known a priori for nulling.

Interface 206 is an input and/or output device, set of devices, and/or software interface, and enables avionics system 200 to communicate with other components of AESA system 10. In addition, interface 206 can provide means of digital or analog signal communication with other components of aircraft 12, and/or a human interface operable by a human user such as a pilot or technician. In some embodiments, interface 206 can be a machine-to-machine interface such as a transceiver or adapter whereby a user interacting with a remote device can indirectly interface with avionics system 200.

AESA 210 is a phased array, e.g. installed on a common antenna, of multiple discrete RF channels 214 with associated antenna elements 212. As principally described herein, AESA 210 can be used for radar applications. More generally, however, AESA 210 can additionally or alternatively be used for transmission and reception of radiation for other purposes, such as targeted or localized communication. Each antenna element 212 and associated RF channel 214 can, in some embodiments, act as both an emitter (i.e., generating components of beams of AESA 210 in cooperation with other RF channels 214 as a phased array) and a receiver (i.e., receiving radar returns for processing by avionics system 200). Active antenna elements 212 collectively define the aperture of AESA 210, and are each capable of radiating an independent signal from respective RF channel 214. As noted above RF channels 214 can at least include a dedicated BFIC and TRM governed by beamforming module 220 (see below). RF channels 214 can have a serial peripheral interface (SPI) or non-serial bus. More generally, however, any appropriate signal channel can be used, so long as each RF channel 214 making up AESA 210 is capable of independent adjustment by and reporting to avionics system 200. As illustrated in FIG. 2, each antenna element 212 shares a common horizontal electric field polarization E with AESA 210, as a whole. More generally, however, other electric field polarizations can be shared by all elements 212 and by AESA 212 as a whole, including vertical or other-angled linear polarizations and/or circular polarizations.

In the illustrated embodiment, AESA 210 consists of a multitude of independently controllable RF channels 214 with associated antenna elements 212 distributed in a rectangular arranged on orthogonal axes. More generally, however, physical locations of antenna elements 212 need not always be physically arranged along axes forming independent bases, and alternative array geometries can be simulated at beamforming, notwithstanding physical locations of each antenna element 212. Furthermore, although AESA 210 is depicted as a dense array of active elements 212, sparser arrangements of active emitters (i.e., elements 212) can also be used, so long as array gaps to not introduce significant unwanted signal periodicity.

Non-radar sensors 216 can include any sensors coupled to avionics system 200, and not directly affected by the functioning of AESA system 10. Non-radar sensors 216 can, for example, include non-radar-based altitude sensors, air data probes, ice detection systems, and landing gear status sensors, to name a few non-limiting examples. As noted below and discussed in greater detail with reference to FIG. 4, sensor data from non-radar sensors 216 can in some embodiments be used in steps of AESA monopulse beam nulling to reduce ground scatter or otherwise minimize noise or interference, or facilitate low probability of intercept radar and/or communications.

Memory 204 is illustrated as hosting several functional software modules 220, 230, 240, and 250. These modules are collectively responsible for controlling radiation emission and processing return signals as known in the art, and are executed by avionics system 200 using processor 202. More specifically, beamforming module 220 is responsible for specifying amplitude and phase or time delay of radiation emission from all RF channels 214 as a phased array to produce multiple monopulse beams, while return processing module 230 is responsible for amplitude- or phase/time delay-based comparison of return signals, general noise reduction, and in some embodiments, imaging based on radar returns. In general, although discussion herein focuses illustratively on processing based at least in part on RF channel phase, the approaches set forth herein are equivalently applicable to time delay-based beamforming and return processing, and can be more generally described as approaches applicable to a time-based parameter (e.g., time delay or phase).

Beamforming module 220 can be or include a beam steering controller (BSC) that collectively controls BFICs of each RF channel 214. In the illustrative embodiments principally described herein, beamforming module 220 defines three beams—a sum beam Σ, and an azimuth difference beam Δₐ, and an elevation difference beam Δₑ. Sum beam Σ can, for example, be defined by a Taylor-weighted beam profile to reduce sidelobe amplitude, while difference beams Δₐ and Δₑ can, for example, be defined by Bayliss-weighted beam profiles, Taylor-weighted beam profiles, and/or split Taylor-weighted beam profiles.

As shown in FIG. 2, memory 204 also can also host geolocation module 240 and nulling module 250. Geolocation module 240 is responsible for ascertaining a spatial position and vector of aircraft 12, and for retrieving and providing surface data corresponding to the aircraft's geolocation. Geolocation module 240 can, for example, ascertain location of aircraft 12 by matching radar returns to databases of known terrain in combination with route planning/navigation data and information from non-radar sensors 216 including GPS data and altitude data. Geolocation module 240 can access stored location-specific surface information from memory 204, which can include Terrain Avoidance and Warning System (TAWS) database data, Google Maps+ data, or any other publicly available information regarding terrain location and elevation, proprietary radar database data (e.g. collected under neutral weather conditions), and more generally any pre-retrieved data set identifying expected ground geometry based on location.

Just as geolocation module 240 can be used by AESA system 10 to identify desired nulling locations to avoid ground clutter, alternative or additional modules 240 can (e.g., in cooperation with AESA 210 and/or non-radar sensors 216) be used to identify non-geographical or not purely geographical desired nulling locations. In illustrative examples, alternative and/or additional module 240 can include modules capable of identifying relative locations and frequency characterizations of jamming or signal congestion sources, and/or locations to which transmission is undesirable for reasons other than backscatter avoidance—for example, to reduce contribution to signal congestion, to avoid interception of communications, and/or to avoid detection of radar activity.

Nulling module 250 is provides corrections to beamforming module 220 in the form of calibrations 260, with each calibration 260 corresponding to an individual RF channel 214. More specifically, nulling module 250 is responsible for computationally defining beam regions responsible for ground scatter based, e.g., on feedback from geolocation module 240, and for adjusting amplitudes and phases/time delays of all RF channels 214 of AESA 210 to ensure a desirable signal to noise (clutter) ratio by creating geographically coincident nulls in all beams (Σ, Δₐ, and Δₑ) corresponding to desired nulling locations for radiation patterns transmitted from AESA 210. Nulling module 250 is responsible for three principal tasks: (1) identifying locations for beam nulling; (2) ensuring alignment of nulls across all 3 beams; and (3) generating configurations corresponding to these nulls, to be applied in beamforming by beamforming module 220.

In general, two broad categories of approaches are available for null steering: using a priori knowledge of desired null location, such as knowledge of a geographic location and surroundings for the avoidance of ground scatter; and digital signal processing using radar and/or other available sensor data to identify desired null locations in real-time. These approaches can be combined. As noted above, the identification of locations for beam nulling can be assisted by a priori knowledge of relative ground location using geolocation module 240. In some embodiments, null location can also be actively and adaptively steered based on radar feedback (see, e.g., U.S. Pat. No. 11,754,706B2), predicated at least in part on phase-of-flight (e.g., identifying take-off or landing based on radio altitude, or landing gear status, from non-radar sensors 216), and/or responsive to anticipated mission or environmental conditions (e.g., while in hostile airspace, or in urban environments with significant signal congestion). In some embodiments, identification of ideal null locations can be a function of sensor fusion aggregating sensor inputs including inputs both from AESA 210 and from multiple non-radar sensors 216.

Extremely precisely localized nulling is ideal in multiple applications, including as means to allow discernment of near-ground weather conditions, but improvements in signal-to-clutter ratio are obtainable even with some degree of imprecision in null location steering, so long as nulls of all beams (Σ, Δₐ, and Δₑ) coincide. Mismatch or misalignment of nulls across beams, however, can introduce unacceptable systemic discrepancies in resulting composite error signals. It is essential, therefore, to ensure that nulls of all beams remain spatially (geographically) coincident at all times. Nulling module 250 can, for example, optimize calibrations 260 computationally to ensure this coincidence of beams. In one such embodiment, calibrations 260 can be generated by particle swarm optimization (PSO). More generally, any robust optimizer can be used that is relatively unsusceptible to becoming caught in local minima. In some alternative embodiments, nulling module 250 can use reinforcement learning or other machine learning processes.

In at least some embodiments, nulling module 250 converges iteratively on ideal prospective calibration states by PSO using scoring based on all three beams, taken together. Beam characteristics can be predicted analytically as array factors including active radiating element radiation patterns within the array aperture's mutual coupling environment as a whole, via inverse Fourier transform (IFT), and tested in real time by operating briefly under a set of prospective calibrations and evaluating resulting null quality. Calibrations resulting in successful nulls can be retained, i.e., in current operation and/or for future reference. More specifically, nulling can be evaluated by operating AESA 210 in both null and non-null modes, and determining whether the application of a null sufficiently reduces resulting ground clutter. Nulling module 250 allows avionics system 200 to reduce ground clutter returns from monopulse radar 100 at relatively low computational cost. The operation of nulling module 250 is described in greater detail below with reference to FIGS. 3 and 4.

FIG. 3 is a simplified overlay providing an example of ground clutter nulling using the system of FIG. 2 in the context of sidelobe ground clutter. FIG. 3 illustrates aircraft 12 (with monopulse radar 100) near the ground, e.g., during takeoff or landing, and provides examples of nulling for monopulse beams 302, depicting unperturbed (pre-nulling) radiant plots 304 alongside post-nulling beams 310. FIG. 3 illustrates unperturbed radiant plots 304s, 304a, and 304e corresponding to sum beam Σ, azimuth beam Aa, and elevation beam Ae, respectively (collectively referred to as unperturbed radiant plots 304 for pre-nulling beams). Unperturbed radiant plots 304 describe lobe patterns of each beam without nulling for ground clutter suppression. In each unperturbed radiant plot 304, a corresponding desired null location 306s/a/e (collectively, desired null locations 306), e.g., a location of anticipated ground clutter, is also identified, e.g. based on a priori terrain knowledge (e.g., from geolocation module 240) and/or adaptive tuning. Desired null locations 306 correspond to spatial ground locations. In example provided in FIG. 3, desired null locations 306 are located principally at cardinal sidelobes at low elevation corresponding to a (known) distance from ground.

As discussed above with reference to nulling module 250 of FIG. 2, and further below with reference to method 400 of FIG. 4, nulling module 250 both generally identifies desired null locations 306, and generates configurations used by beamforming module 220 to place nulls at those locations as shown in nulled plots 308e, 308s, and 308a (collectively, nulled plots 308). Specifically, nulling module 250 can generate simulated modified aperture patterns selected via computationally optimized aperture pattern synthesis to produce 3-beam geographically coincident nulls (i.e., via beamforming module 220 and RF channels 214). Although this optimization can be PSO, any sufficiently fast, efficient and robust (i.e., relatively unsusceptible to capture by local maxima/minima) computational approach can equivalently be used, including Newton gradient-based optimization and neural net approaches. As shown in FIG. 3, a single simulated null optimization determines adjustments to all three beams, ensuring that resultant null locations in each beam coincide. Adjusted radiant plots 312s, 312a, 312e (collectively, radiant plots 312) represent adjusted lobe patterns of sum beam Σ, azimuth beam Δₐ, and elevation beam Δₑ, respectively, and illustrate the absence of radiation emission at desired null locations 306. Radiant plots 312 thus illustrate radiation patterns selected to dramatically reduce radiation towards desired null location 306. In the illustrated example nulling at desired null location 306 can reduce ground clutter, but more generally the geographic alignment of a null at desired null location 306 can serve other purposes, as noted above, including low probability of intercept transmission, signal decongestion, and jamming resistance.

FIG. 4 presents a method flowchart describing method 400, a method of operation of AESA system 10 with particular emphasis on the functions of nulling module 250. Method 400 describes a FATE methodology for nulling using calibration achieved via iterative bisection and computational optimization as introduced above with respect to FIGS. 1-3. Method 400 includes steps 402, 404, 406, 408, 410, 412, 414, 416, 418, 420, 422, 424, and 426. In the most general case, method 400 is broadly applicable to both Tx and Rx operation of AESA system 10. Operation during Rx modes, particularly, can be used to generate nulls during Rx modes of half-duplexed radar operation, thereby reducing unwanted returns regardless of Tx mode. In embodiments wherein method 400 is applied to communication rather than radar, method 400 can advantageously also be applied to Tx modes. In some embodiments, approaches as set forth herein and as described below with reference to FIG. 4 can be used in half-duplex systems for Rx operation, and combined with Tx modes with increased transmission power and localized nulling at desired nulling locations, as noted above.

In step 402, nulling module 250 receives location information regarding a desired null location 306 such as a ground clutter source from surface geometry. This location information identifies the desired null location relative to monopulse radar 100 on aircraft 12. As noted above, geolocation information can be retrieved from geolocation module 240, e.g., in the form of matching to terrain mapping provided through TAWS or other databases. Additionally and/or alternatively, geolocation information, situational or mission information, and environmental information can be derived and/or adaptively adjusted based on current sensor readings aboard aircraft, e.g., from monopulse radar 100 and/or non-radar sensors 216.

Using the location information received at step 402 (e.g., a desired null location 306), nulling module 250 determines a spatial location of a null within the antenna pattern of monopulse radar 100 at step 404. As presented in the example illustrated in FIG. 3, this spatial location corresponds to an expected location of the ground clutter source, within the antenna pattern of AESA system 100.

At step 406, nulling module 250 next generates ideal coefficients for AESA amplitudes and time delays and/or phase excitations for each RF channel 214 tailored to generate coinciding nulls in the sum beam Σ, azimuth beam Δₐ, and elevation beam Δₑ at the spatial location identified in step 404. These ideal parameters can, for example, be quantized (digital) values. As noted above with reference to FIGS. 2 and 3, RF channel amplitudes and phases/time delays are computationally optimized together, i.e., as a single M-dimensional optimized state, rather than on a beam-by-beam basis, to maintain spatial coincidence of all three beams. Nulling can consequently be adjusted as needed (i.e., re-optimized) with each change in orientation of any beam, for example when sweeping difference beams Δₐ, Δₑ, or when adjusting boresight orientation of AESA 210 as a whole. As noted above, although this disclosure focuses illustratively on phase-based formulations of method 400, time delay-based versions are equivalently possible.

For simplicity of explanation, this disclosure has presented beamforming module 220 and nulling module 250 as separate software modules operating on memory 202, with nulling module 250 providing calibrations 260 to beamforming module 220 to introduce nulls at desired spatial locations. More generally, however, functions of beamforming module 220 and nulling module 250 can be intermingled, and/or nulling module 250 can be integrated into the operation of beamforming module 220 such that optimization for nulling (e.g., via reinforcement learning or PSO) is incorporated into the core functioning of beamforming module 220.

At step 408, nulling module 250 generates calibrations 260 via a FAST Array Test Environment (FATE) calibration methodology using extensions of Hadamard orthonormal encoding, or non-Hadamard orthonormal “on/off” sequencing of single or small groups of elements such that only a subset of RF channels 214 are coherently combined during the calibration process. These calibrations 260 are based on idealized AESA amplitude and phase/time delay excitations generated at step 406 for and/or via beamforming module 220. Calibrations 260 can, for example, be analog signal parameters for each RF channel 214 rapidly selected to produce substantially these idealized phases/time delays and amplitudes. Step 408 includes sub-steps 410 and 412 to iteratively converge on ideal amplitudes and phases of RF channels 214 as determined in step 406. FATE compensates for actual hardware nonidentities of active and passive RF circuitry by rapidly experimentally mapping all 2^{N} amplitude and 2^{M} phase/time delay states available across BFICs and TRMs of RF channels 214 to generate corrections to amplitude and phases/time delays produced in step 406.

At step 410, nulling module 250 generates or improves upon initial or previous calibration values, e.g., providing adjustments for second order interactions between RF channel amplitudes and phases or time delays. Step 410 is performed through iterative gain table bisections, i.e. by iterative bisection of a table of normalized amplitude/gain values for each array element. More specifically, nulling module 250 calculates expected aperture excitation as known in the art (e.g. via a Taylor taper) based on radiating element coordinates in AESA 210 and desired sidelobe levels (SLLs) to generate an N-dimensional vector representation Gₙ of desired gain responses (e.g., from −24 db to 0 db) for each corresponding element n, based on outputs of step 406. A measurement of maximum gain response is taken experimentally with one or more center elements of AESA 210 maximized and all other elements turned off, and used to normalize all other gain response values. A measurement of minimum gain response is taken with all array elements maximally attenuated to define a “zero” minimum gain state M_{f}.

With each iteration of step 410, for each element of AESA 210, an actual gain response Mᵣ is experimentally observed at a midpoint normalized gain setting. Gain response for each ESA element can be expected to increase monotonically with element gain. Thus, if normalized gain response (i.e., Mᵣ-M_{f}) is less than desired gain response Gₙ, gain can be assumed to be too low; if more, too high. Gain table bisection in step 410 consists of iteratively converging on an optimal gain value for each element of AESA 210 by selecting new evaluation ranges (between a previous midpoint and a previous minimum or maximum) based on this evaluation, as will be understood in the art. Illustratively, a series of three iterations of gain table bisection might begin with evaluating gain responses at a midpoint (63) of an initial range, e.g., [0,127]. Upon determining that this phase response is greater than a desired value Φₙ, a next iteration of step 410 would then evaluate phase response at a midpoint of the lower bisection of this initial range, i.e. a midpoint (31) of reduced range—[0,63], carrying forward the earlier example. If this sensed phase response is less than desired value Φₙ, a third iteration of step 410 would then evaluate phase response at a midpoint of the upper bisection of the range of the previous bisection, i.e. a midpoint (41) of further reduced range-carrying the earlier example further: [31,63]. Through this iterative approach, FATE allows nulling module 250 to converge upon optimal or adequate actual phase response values for each element of AESA 210, based on theoretical values prescribed via optimization (e.g., PSO) performed at step 406.

At step 412, nulling module 250 generates or improves upon initial or previous phase or time delay calibration values, much as described above with respect to step 412, e.g., providing adjustments for second order interactions between RF channel amplitudes and phases or time delays. Step 412 is performed through iterative phase table bisection in a process similar to the gain table bisection process of step 410. Phase is periodic, i.e., with phase of 540° equivalent to 180°. Consequently, phase response varies non-monotonically with phase settings of RF channels when evaluating phase across ranges greater than 360°, e.g., in a sawtooth pattern. Bisection, therefore, is made possible by producing an “unwrapped” phase table adjusted to shift actual absolute phase within each 360° region by an offset relative to adjacent 360° regions so as to align adjacent regions monotonically and continuously. Using this “unwrapped” phase table, bisection is performed for phase substantially as described above with respect to gain, i.e., by iteratively converging on experimentally observed phase values that approach desired values Φₙ through successively narrower ranges. As with gain responses in step 410, desired phase responses Φₙ are determined for each element n based on nominal values determined at step 406.

As illustrated in FIG. 4, gain and phase bisection according to steps 410 and 412 is repeated with successively narrower windows for each element multiple times. In an illustrative embodiment, this iteration process can include a set number of iterations for each bisection step 410, 412, e.g., seven gain bisection iterations in step 410. In other embodiments, this iteration process can continue until nominal and observed values of gain and phase response are sufficiently close (i.e., with less than a preset threshold difference).

As also illustrated in FIG. 4, gain and phase bisection steps 410 and 412, respectively, can alternate. In some embodiments, for example, method 400 may proceed to steps 412 after a preset number of converging iterations of step 410, or after achieving an acceptable gain value. Similarly, in some embodiments gain bisection can be revisited (i.e., by additional steps 410) following one or more iterations of phase bisection via step 410. FIG. 4 generally illustrates steps 410 occurring before steps 412, such that at least some gain calibration occurs before phase calibration. In some embodiments, however, at least some phase bisection steps 412 can be performed before final gain bisections steps 410. Because adjustments to phase can affect gain, and vice versa, both phase and gain bisection can in some embodiments be advantageously reevaluated after adjust the other of steps 410, 412. In general, (re) evaluating gain calibration after adjusting phase or time delay calibration, or vice versa, allows method 400 to account for second order effects of each on the other.

Sub-steps 410 and 412 of FATE calibration step 408 generate provisional calibrations 260 for each element of AESA 210. The quality of these nulls is then tested in steps 414 and 416. In step 414, boresight radiation patterns are evaluated to determine whether the null holds (i.e., a null is generated at the desired null location) for Σ beam output. This evaluation can be performed theoretically, e.g., computationally via simulation of expected radar returns. More specifically, far field array factors can be predicted via Fourier transform processing of post-calibration measured amplitudes and phases of each RF channel 214. This approach can, for example, use comparisons against far field patterns based on National Institute of Standards and Technology (NIST) qualified near field antenna range measurements. Alternatively and/or additionally, nulling quality can be checked by briefly running AESA 210 with selected calibrations 260, and comparing resulting radar returns against returns using non-nulled calibration, e.g., at compact or far field test facilities. Figures of Merit (FoMs) for nulling of resulting radiation patterns are judged against the results of step 412 to set the conditional logic of step 414. FoMs can, for example, include null location (e.g., with respect to step locations identified in step 404), null angular extent, and null depth as referenced to the peak of the composite far field beam.

If the borescope radiation pattern performs as expected, i.e., with synchronous nulls having adequate FoM as set forth above, method 400 proceeds to step 416. In Step 416, the post-calibrated AESA is electronically scanned through a specified conical scan volume and the FoMs set forth above are qualified as a function of scan angle for difference beam (Δ_{az} Δₑₗ) outputs, generally as set forth above with respect to steps 410-412.

If FoMs are satisfactory at both step 414 and step 416, the calibrations generated at step 408 are acceptable for operation of AESA 210. If Σ output is unsatisfactory (i.e. if FoM evaluation indicates that nulling does not hold for Σ beam output), method 400 returns to FATE calibration step 408 with more stringent bisection requirements such as increased iteration count or narrower satisfaction thresholds. If Δ_{az} and/or Δₑₗ outputs are not satisfactory (i.e. if nulling does not hold for scan outputs), outputs of monopulse comparator (MPCs) of channels 214 may be nonideal, and method 400 returns to step 406 for new computational optimization of ideal nulling coefficients using MPC phase/gain as additional inputs.

In some embodiments, the generation of at least some calibrations at step 408 and the evaluation of those calibrations in steps 410-416 can be performed in real time, e.g., during aircraft flight, with such calibrations being stored transiently and new calibrations for nulling being generated as-needed. In other embodiments, validated calibrations 260 can be stored persistently (Step 418) in memory 204 and, for example, associated with a priori identified nulling locations identified at step 402. These approaches can be combined, allowing stored calibrations to be retrieved and used by default where available to reduce computational load and allow thorough testing, but supplemented where necessary by nulling calibrations generated in real time. Where validated calibrations associated with a determined null location have already been stored, these validated calibrations can be retrieved (step 420) following step 404 rather than recreated via steps 406-416.

AESA system 10 operates (step 422) in flight using validated nulls that are either newly generated at step 408 and confirmed via steps 410-416, or retrieved at step 420. Operation at specified calibrations can continue until a new null location is needed, e.g., due to movement of aircraft 12, or because ongoing monitoring indicates that the null is no longer correct. In step 424, periodic monitoring is conducted to determine if aircraft in-situ AESA (re) calibration is required. A mission phased Built-in Test (BIT) and prognostics/AESA health monitoring are periodically run during flight to verify AESA performance. This monitoring can, for example, include periodic re-evaluations of null quality as described above with respect to steps 410-416, and/or independent evaluation of interference or clutter in radar returns. If this testing indicates that in-situ recalibration is needed, method 400 returns to step 408 for recalibration.

In some embodiments, some of steps 410/412 and 414/416 may be omitted, e.g., during in-situ/in-flight operation. As aircraft 12 moves and/or AESA 210 reorients, method 400 can begin again from step 402.

### Discussion of Possible Embodiments

The following are non-exclusive descriptions of possible embodiments of the present invention.

A method of operating a monopulse active electronically scanned array (AESA) system including a phased array of radio frequency (RF) channels each having an associated emitter element, the method comprising:

identifying a desired nulling location, the desired nulling location constituting a spatial location relative to the phased array for transmission nulling; computationally optimizing theoretical aperture patterns for the monopulse AESA system to align geographically coincident nulls of each of a plurality of beams of the monopulse AESA system with the desired nulling location, the theoretical aperture patterns including nominal gain and at least one of phase and time delay values for each of the RF channels; calibrating actual gain of each RF channel corresponding to the optimizing theoretical aperture patterns by iteratively bisecting a gain table for each RF channel through successively narrower gain ranges converging upon a corresponding nominal gain value for that RF channel; and calibrating an actual time-based parameter comprising phase or time delay for each RF channel corresponding to the optimizing theoretical aperture patterns by iteratively bisecting a time-based parameter table for each RF channel through successively narrower time-based parameter ranges converging upon a corresponding nominal gain value for that RF channel; and driving each of the RF channels according to the calibrated actual parameter and calibrated actual gain for each of the phased array of RF channels.

The method of the preceding paragraph can optionally include, additionally and/or alternatively, any one or more of the following features, configurations and/or additional components:

A further embodiment of the foregoing method, wherein calibrating the actual time-based parameter further comprises generating an unwrapped time-based parameter table by offsetting 360° sections of a corresponding sensed time-based parameter a respective RF channel operation by an offset selected to align 360° sections monotonically and continuously with adjacent 360° sections, such that iterative bisection is performed on the unwrapped time-based parameter table.

A further embodiment of the foregoing method, wherein at least one of the iterations of bisecting the gain table occurs after at least one of the iterations of bisecting the time-based parameter table.

A further embodiment of the foregoing method, wherein at least one of the iterations of bisecting the time-based parameter table occurs after at least one of the iterations of bisecting the gain table.

A further embodiment of the foregoing method, wherein computationally optimizing theoretical aperture patterns for the monopulse AESA system comprises executing a computational optimization of an aperture pattern synthesis of all of the plurality of beams of the monopulse AESA system.

A further embodiment of the foregoing method, wherein the computational optimization is a particle swam optimization.

A further embodiment of the foregoing method, wherein computational optimization comprises at least one of Newton gradient-based optimization, a neural net optimization, and a genetic algorithm.

A further embodiment of the foregoing method, further comprising testing nulling provided by the calibrated actual time-based parameter and calibrated actual gain, and generating new calibrations if the testing indicates that the nulling is inadequate.

A further embodiment of the foregoing method, wherein testing nulling comprises evaluating nulling Figures of Merit (FoMs) including null location, null angular extent, and null depth. A further embodiment of the foregoing method,

A further embodiment of the foregoing method, wherein testing nulling comprises evaluating FoM for nulling of a sum beam output of the AESA system, the method further comprising restarting the calibration of the actual gain and the actual time-based parameter if the FoM indicate an inadequate null at the nulling location.

A further embodiment of the foregoing method, wherein restarting the calibration of the actual gain and the actual time-based parameter comprises re-running the calibration of the actual gain and the actual time-based parameter with stricter calibration requirements.

A further embodiment of the foregoing method, wherein testing nulling comprises evaluating FoM for nulling of outputs of an elevation difference beam and an azimuth difference beam of the AESA system, the method further comprising restarting the computational optimization of theoretical aperture patterns if the FoM indicate an inadequate null at the nulling location.

A further embodiment of the foregoing method, wherein restarting the computational optimization of theoretical aperture patterns comprises performing the computational optimization of the theoretical aperture patterns with the actual gain and the actual time-based parameter for each of the RF channels as inputs.

An aerial monopulse active electronically scanned array (AESA) system comprising: a phased array of independently controllable radio frequency (RF) channels, each RF channel having an associated emitter element; a location module configured to identify a desired null location relative to an antenna pattern of the phased array; a nulling module configured to: compute a nominal gain and a nominal time-based parameter comprising at least one of phase and time delay for each of the RF channels corresponding to a geographically coincident null of each of a plurality of AESA beams, situated at the desired null location; and calibrate actual values of the gain and the time-based parameter for each of the RF channels by: iteratively bisecting a gain table of the actual gain for each RF channel such that successive iterations converge on the nominal gain for that RF channel; and iteratively bisecting a time-based parameter table of the actual time-based parameter for each RF channel such that successive iterations converge on the nominal time-based parameter for that RF channel; and a beamforming module configured to cause the phased array to emit a radiation pulse including the plurality of AESA beams, according to the simulated aperture pattern, by driving each of the RF channels at respective of the calibrated actual time-based parameter and calibrated actual gain. The aerial monopulse AESA system of the preceding paragraph can optionally include, additionally and/or alternatively, any one or more of the following features, configurations and/or additional components:

A further embodiment of the foregoing aerial monopulse AESA system, wherein each RF channel includes both a Beam Forming Integrated Circuit (BFIC) and an Transmit/Receive Module (TRM).

A further embodiment of the foregoing aerial monopulse AESA system, wherein the nulling module is configured to generate calibrations of the BFICs of each RF channel according to the simulated aperture patterns, such that the calibrations of the BFICs of each RF channel specify the time-based parameter and amplitude of that RF channel.

A further embodiment of the foregoing aerial monopulse AESA system, wherein the plurality of AESA beams comprises a sum beam, an azimuth difference beam, and an elevation difference beam.

A further embodiment of the foregoing aerial monopulse AESA system, wherein the computing of nominal time-based parameters and gains comprises a particle swarm optimization.

A further embodiment of the foregoing aerial monopulse AESA system, wherein the nulling module is further configured to test whether the calibrated actual time-based parameters and gains produce satisfactory synchronous nulls of all of the plurality of AESA beams.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of operating a monopulse active electronically scanned array (AESA) system including a phased array of radio frequency (RF) channels each having an associated emitter element, the method comprising:
identifying a desired nulling location, the desired nulling location constituting a spatial location relative to the phased array for transmission nulling;
computationally optimizing theoretical aperture patterns for the monopulse AESA system to align geographically coincident nulls of each of a plurality of beams of the monopulse AESA system with the desired nulling location, the theoretical aperture patterns including nominal gain and at least one of phase and time delay values for each of the RF channels;
calibrating actual gain of each RF channel corresponding to the optimizing theoretical aperture patterns by iteratively bisecting a gain table for each RF channel through successively narrower gain ranges converging upon a corresponding nominal gain value for that RF channel; and
calibrating an actual time-based parameter comprising phase or time delay for each RF channel corresponding to the optimizing theoretical aperture patterns by iteratively bisecting a time-based parameter table for each RF channel through successively narrower time-based parameter ranges converging upon a corresponding nominal gain value for that RF channel; and
driving each of the RF channels according to the calibrated actual parameter and calibrated actual gain for each of the phased array of RF channels.

2. The method of claim 1, wherein calibrating the actual time-based parameter further comprises generating an unwrapped time-based parameter table by offsetting 360° sections of a corresponding sensed time-based parameter a respective RF channel operation by an offset selected to align 360° sections monotonically and continuously with adjacent 360° sections, such that iterative bisection is performed on the unwrapped time-based parameter table.

3. The method of claim 1, wherein at least one of the iterations of bisecting the gain table occurs after at least one of the iterations of bisecting the time-based parameter table.

4. The method of claim 3, wherein at least one of the iterations of bisecting the time-based parameter table occurs after at least one of the iterations of bisecting the gain table.

5. The method of claim 1, wherein computationally optimizing theoretical aperture patterns for the monopulse AESA system comprises executing a computational optimization of an aperture pattern synthesis of all of the plurality of beams of the monopulse AESA system.

6. The method of claim 5, wherein the computational optimization is a particle swam optimization.

7. The method of claim 5, wherein computational optimization comprises at least one of Newton gradient-based optimization, a neural net optimization, and a genetic algorithm.

8. The method of claim 1, further comprising testing nulling provided by the calibrated actual time-based parameter and calibrated actual gain, and generating new calibrations if the testing indicates that the nulling is inadequate.

9. The method of claim 8, wherein testing nulling comprises evaluating nulling Figures of Merit (FoMs) including null location, null angular extent, and null depth.

10. The method of claim 9, wherein testing nulling comprises evaluating FoM for nulling of a sum beam output of the AESA system, the method further comprising restarting the calibration of the actual gain and the actual time-based parameter if the FoM indicate an inadequate null at the nulling location.

11. The method of claim 10, wherein restarting the calibration of the actual gain and the actual time-based parameter comprises re-running the calibration of the actual gain and the actual time-based parameter with stricter calibration requirements.

12. The method of claim 9, wherein testing nulling comprises evaluating FoM for nulling of outputs of an elevation difference beam and an azimuth difference beam of the AESA system, the method further comprising restarting the computational optimization of theoretical aperture patterns if the FoM indicate an inadequate null at the nulling location.

13. The method of claim 12, wherein restarting the computational optimization of theoretical aperture patterns comprises performing the computational optimization of the theoretical aperture patterns with the actual gain and the actual time-based parameter for each of the RF channels as inputs.

14. An aerial monopulse active electronically scanned array (AESA) system comprising:
a phased array of independently controllable radio frequency (RF) channels, each RF channel having an associated emitter element;
a location module configured to identify a desired null location relative to an antenna pattern of the phased array;
a nulling module configured to:
compute a nominal gain and a nominal time-based parameter comprising at least one of phase and time delay for each of the RF channels corresponding to a geographically coincident null of each of a plurality of AESA beams, situated at the desired null location; and
calibrate actual values of the gain and the time-based parameter for each of the RF channels by:
iteratively bisecting a gain table of the actual gain for each RF channel such that successive iterations converge on the nominal gain for that RF channel; and
iteratively bisecting a time-based parameter table of the actual time-based parameter for each RF channel such that successive iterations converge on the nominal time-based parameter for that RF channel; and
a beamforming module configured to cause the phased array to emit a radiation pulse including the plurality of AESA beams, according to the simulated aperture pattern, by driving each of the RF channels at respective of the calibrated actual time-based parameter and calibrated actual gain.

15. The aerial monopulse AESA system of claim 14, wherein each RF channel includes both a Beam Forming Integrated Circuit (BFIC) and an Transmit/Receive Module (TRM).

16. The aerial monopulse AESA system of claim 15, wherein the nulling module is configured to generate calibrations of the BFICs of each RF channel according to the simulated aperture patterns, such that the calibrations of the BFICs of each RF channel specify the time-based parameter and amplitude of that RF channel.

17. The aerial monopulse AESA system of claim 14, wherein the plurality of AESA beams comprises a sum beam, an azimuth difference beam, and an elevation difference beam.

18. The aerial monopulse AESA system of claim 14, wherein the computing of nominal time-based parameters and gains comprises a particle swarm optimization.

19. The aerial monopulse AESA system of claim 14, wherein the nulling module is further configured to test whether the calibrated actual time-based parameters and gains produce satisfactory synchronous nulls of all of the plurality of AESA beams.
